(19) United States
(12) Patent Application Publication
(10) Pub. No.: US 2026/0286167 A1
(43) Pub. Date: Sep. 24, 2026

(54) RESIN COMPOSITION FOR COLORED COATING OF OPTICAL FIBER, OPTICAL FIBER, AND OPTICAL FIBER RIBBON

(71) Applicant: SUMITOMO ELECTRIC INDUSTRIES, LTD., Osaka (JP)

(72) Inventors: Katsushi HAMAKUBO, Osaka (JP); Noriaki IWAGUCHI, Osaka (JP); Miho IKEGAWA, Osaka (JP); Chiaki TOKUDA, Osaka (JP)

(21) Appl. No.: 18/996,157

(22) PCT Filed: Aug. 7, 2023
(86) PCT No.: PCT/JP2023/028795

§ 371 Date: Jan. 17, 2025

(30) Foreign Application Priority Data
Aug. 26, 2022 (JP) 2022-134775

(51) Int. Cl. C09D 135/02; C03C 25/1065; C03C 25/475; C09D 4/00; C09D 7/61; G02B 6/02; G02B 6/44

(52) U.S. Cl. CPC C09D 135/02; C03C 25/1065; C03C 25/475; C09D 4/00; C09D 7/61; G02B 6/02395; G02B 6/4403

(57) ABSTRACT

A resin composition for colored coating of an optical fiber contains a photopolymerizable compound, a photopolymerization initiator, and a polydimethylsiloxane compound, in which the amount of silicon atoms included in the polydimethylsiloxane compound is 5% by mass or more and 40% by mass or less based on the amount of the polydimethylsiloxane compound.

### TECHNICAL FIELD

The present disclosure relates to a resin composition for colored coating of an optical fiber, an optical fiber, and an optical fiber ribbon.

The present patent application claims priority based on Japanese Patent Application No. 2022-134775 filed on Aug. 26, 2022, the entire disclosure of which is incorporated herein by reference.

Generally, an optical fiber has a coating resin layer for protecting a glass fiber, which is an optical transmission medium. The coating resin layer has, for example, a primary resin layer and a secondary resin layer. The outermost layer of the coating resin layer is composed of a colored resin layer for identification of the optical fiber (see, for example, Patent Literatures 1 to 3).

### CITATION LIST

### Patent Literature

Patent Literature 1: JP H6-242355 A
Patent Literature 2: JP 2003-279811 A
Patent Literature 3: WO 2016/047002 A1

### SUMMARY OF INVENTION

A resin composition for colored coating of an optical fiber according to an aspect of the present disclosure contains a photopolymerizable compound, a photopolymerization initiator, and a polydimethylsiloxane compound, in which an amount of silicon atoms included in the polydimethylsiloxane compound is 5% by mass or more and 40% by mass or less based on an amount of the polydimethylsiloxane compound.

### BRIEF DESCRIPTION OF DRAWINGS

FIG. 1 is a schematic cross-sectional view illustrating an example of an optical fiber according to the present embodiment.

FIG. 2 is a schematic cross-sectional view illustrating an example of the optical fiber according to the present embodiment.

FIG. 3 is a schematic cross-sectional view illustrating an example of an optical fiber ribbon according to the present embodiment.

### DESCRIPTION OF EMBODIMENTS

### Problem to Be Solved by Present Disclosure

Optical fibers may be used in the form of optical fiber ribbons in which a plurality of optical fibers are arranged side by side and integrated together with a resin for ribbon. In optical fiber ribbons that use optical fibers having a colored resin layer, a phenomenon so-called “color peeling”, in which when an operation of removing the ribbon material to take out the optical fibers is performed, the colored resin layer is peeled from the optical fiber, may occur. Particularly, when the linear speed is increased when the colored resin layer is formed, the color peeling is likely to occur.

It is an object of the present disclosure to provide a resin composition for colored coating of an optical fiber, which enables production of an optical fiber that is less susceptible to color peeling, an optical fiber, and an optical fiber ribbon.

### Effect of Present Disclosure

According to the present disclosure, a resin composition enabling production of an optical fiber that is less susceptible to the occurrence of color peeling, a colored coating material for an optical fiber, an optical fiber, and an optical fiber ribbon can be provided.

### DESCRIPTION OF EMBODIMENTS OF PRESENT DISCLOSURE

First, the contents of the embodiments of the present disclosure will be listed and described.

(1) The resin composition for color coating of an optical fiber according to an aspect of the present disclosure contains a photopolymerizable compound, a photopolymerization initiator, and a polydimethylsiloxane compound, and the amount of silicon atoms included in the polydimethylsiloxane compound is 5% by mass or more and 40% by mass or less based on the amount of the polydimethylsiloxane compound.

With such a resin composition, an optical fiber less susceptible to color peeling can be produced by using a polydimethylsiloxane compound and adjusting the amount of silicon atoms included in the polydimethylsiloxane compound to a specific range.

(2) With regard to the above-described item (1), from the viewpoint of improving the compatibility with the photopolymerizable compound, the polydimethylsiloxane compound may have a (meth)acryloyl group.

(3) With regard to the above-described item (1) or (2), from the viewpoint of increasing the strength of the resin layer, the photopolymerizable compound may include epoxy di(meth)acrylate.

(4) With regard to any one of the above-described items (1) to (3), from the viewpoint of coloring the resin layer, the resin composition according to the present embodiment may further contain titanium oxide.

(5) An optical fiber according to an aspect of the present disclosure includes: a glass fiber including a core and a cladding; a primary resin layer in contact with the glass fiber and coating the glass fiber; a secondary resin layer coating the primary resin layer; and a colored resin layer coating the secondary resin layer, wherein the colored resin layer contains a cured product of the resin composition according to any one of the above-described items (1) to (4). By applying the resin composition according to the present embodiment to the colored resin layer, the wet heat resistance of the optical fiber can be improved without causing color peeling.

(6) An optical fiber according to an aspect of the present disclosure includes: a glass fiber including a core and a cladding; a primary resin layer in contact with the glass fiber and coating the glass fiber; a secondary resin layer coating the primary resin layer; and a secondary resin layer coating the primary resin layer, wherein the secondary resin layer contains a cured product of the resin composition according to any one of the above-described items (1) to (4). By applying the resin composition according to the present embodiment to the secondary resin layer, the wet heat resistance of the optical fiber can be improved without causing color peeling.

(7) An optical ribbon according to an aspect of the present disclosure has a plurality of the optical fiber ribbons according to the above-described item (5) or (6) arranged in parallel and coated with a resin for ribbon. In such an optical fiber ribbon, color peeling does not occur when an operation of taking out the optical fibers is carried out, and the optical fibers can be easily identified.

### DETAILS OF EMBODIMENTS OF PRESENT DISCLOSURE

Specific examples of the resin composition and optical fiber according to the embodiments of the present disclosure will be described, with reference to the drawings as necessary. Incidentally, the present disclosure is not limited to these examples and is indicated by the claims, and all modifications made within the meanings and scopes equivalent to the claims are intended to be included. In the following description, the same reference numerals will be assigned to the same elements in the description of the drawings, and any overlapping description will not be repeated. The term (meth)acrylate in the present specification means acrylate or methacrylate corresponding thereto. The same also applies to other similar expressions such as (meth)acrylic acid.

### (Resin Composition)

The resin composition for color coating of an optical fiber according to the present embodiment contains a photopolymerizable compound, a photopolymerization initiator, and a polydimethylsiloxane compound, and the amount of silicon atoms included in the polydimethylsiloxane compound is 5% by mass or more and 40% by mass or less based on the amount (100% by mass) of the polydimethylsiloxane compound.

The polydimethylsiloxane compound is a compound having a dimethylsiloxane skeleton (—Si(CH₃)₂O—) composed of two methyl groups bonded to a silicon atom and an oxygen atom in the main chain, as a repeating unit. By using a polydimethylsiloxane compound having an amount of silicon atoms (Si) of 5% by mass or more and 40% by mass or less, color peeling can be reduced.

The amount of Si included in the polydimethylsiloxane compound can be measured by inductively coupled plasma optical emission spectroscopy (ICP-OES) of the polydimethylsiloxane compound. From the viewpoint of further suppressing color peeling, the amount of Si may be 8% by mass or more, 10% by mass or more, 14% by mass or more, or 16% by mass or more. Furthermore, from the viewpoint of improving the stability of the resin composition, the amount of Si may be 38% by mass or less, 36% by mass or less, 34% by mass or less, or 32% by mass or less.

From the viewpoint of improving the stability of the resin composition, the polydimethylsiloxane compound may have a (meth)acryloyl group. The polydimethylsiloxane compound may have a (meth)acryloyl group in a side chain or at an end. A polydimethylsiloxane compound having a (meth)acryloyl group can be copolymerized with the photopolymerizable compound that will be described below. In the present embodiment, the polydimethylsiloxane compound having a (meth)acryloyl group is not included in the photopolymerizable compound. The number of (meth)acryloyl groups included in the polydimethylsiloxane compound may be 1 or more or 2 or more, and may be 10 or less or 8 or less. From the viewpoint of further improving the stability of the resin composition and also further reducing color peeling of the colored resin layer, the polydimethylsiloxane compound may have 2 or more and 8 or fewer (meth)acryloyl groups, and the amount of Si may be 14% by mass or more and 36% by mass or less.

From the viewpoint of controlling the adhesive force between the colored resin layer and the resin for ribbon, the content of the polydimethylsiloxane compound may be 0.5 parts by mass or more, 1.0 parts by mass or more, or 1.5 parts by mass or more, and may be 10.0 parts by mass or less, 8.0 parts by mass or less, or 6.0 parts by mass or less, with respect to 100 parts by mass of the total amount of the polydimethylsiloxane compound and the photopolymerizable compound. The photopolymerizable compound according to the present

embodiment is distinguished from the polydimethylsiloxane compound having a (meth)acryloyl group in view of not having the dimethylsiloxane skeleton. From the viewpoint of increasing the strength of the resin layer, the photopolymerizable compound may include epoxy di(meth)acrylate. As the epoxy di(meth)acrylate, a reaction product of a diglycidyl ether compound having a bisphenol skeleton and a compound having a (meth)acryloyl group, such as (meth)acrylic acid, can be used.

Examples of the epoxy di(meth)acrylate include a (meth)acrylic acid adduct of bisphenol A diglycidyl ether, a (meth)acrylic acid adduct of bisphenol AF diglycidyl ether, and a (meth)acrylic acid adduct of bisphenol F diglycidyl ether.

From the viewpoint of further increasing the strength of the resin layer, the content of the epoxy di(meth)acrylate may be 30 parts by mass or more, 40 parts by mass or more, or 45 parts by mass or more, and may be 70 parts by mass or less, 65 parts by mass or less, or 60 parts by mass or less, with respect to 100 parts by mass of the total amount of the polydimethylsiloxane compound and the photopolymerizable compound.

The photopolymerizable compound according to the present embodiment can further include a photopolymerizable compound (hereinafter, referred to as a “monomer”) other than epoxy di(meth)acrylate.

As the monomer, a monofunctional monomer having one polymerizable group, or a polyfunctional monomer having two or more polymerizable groups can be used. Two or more kinds of monomers may be used as a mixture.

Examples of the monofunctional monomer include (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxy diethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, and isobornyl (meth)acrylate; carboxy group-containing monomers such as (meth)acrylic acid, (meth)acrylic acid dimer, carboxyethyl (meth)acrylate, carboxypentyl (meth)acrylate, and ω-carboxy polycaprolactone (meth)acrylate; heterocyclic ring-containing monomers such as N-(meth)acryloylmorpholine, N-vinylpyrrolidone, N-vinylcaprolactam, N-(meth)acryloylpiperidine, N-(meth)acryloylpyrrolidine, 3-(3-pyridine)propyl (meth)acrylate, and cyclic trimethylolpropane formal acrylate; maleimide-based monomers such as maleimide, N-cyclohexylmaleimide, and N-phenylmaleimide; amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate-based monomers such as aminoethyl (meth)acrylate, aminopropyl (meth)acrylate, N,N-dimethylaminoethyl (meth)acrylate, and tert-butylaminoethyl (meth)acrylate; and succinimide-based monomers such as N-(meth)acryloyloxymethylene succinimide, N-(meth)acryloyl-6-oxyhexamethylene succinimide, and N-(meth)acryloyl-8-oxyoctamethylene succinimide.

Examples of the polyfunctional monomer include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

From the viewpoint of adjusting the Young's modulus of the resin layer, the photopolymerizable compound according to the present embodiment may include an alkylene oxide-modified polyfunctional monomer. The alkylene oxide-modified polyfunctional monomer may have at least one selected from the group consisting of an ethylene oxide (EO) chain and a propylene oxide (PO) chain. The ethylene oxide chain can be denoted as “(EO)n”, and the propylene oxide chain can be denoted as “(PO) n”. n is an integer of 1 or greater, may be 2 or greater or 3 or greater, and may be 30 or less, 25 or less, or 20 or less.

Examples of the alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate polypropylene glycol di(meth)acrylate, propylene oxide-modified bisphenol A di(meth)acrylate, and propylene oxide-modified neopentyl glycol di(meth)acrylate.

Examples of the alkylene oxide-modified tri(meth)acrylate include trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, and pentaerythritol tri(meth)acrylate.

The photopolymerization initiator can be appropriately selected from known radical photopolymerization initiators and used. Examples of the photopolymerization initiator include 1-hydroxycyclohexyl phenyl ketone (Omnirad 184, manufactured by IGM Resins B.V.), 2,2-dimethoxy-2-phenylacetophenone, 1-(4-isopropylphenyl)-2-hydroxy-2-methylpropan-1-one, bis(2,6-dimethoxybenzoyl)-2,4,4-trimethylpentylphosphine oxide, 2-methyl-1-[4-(methylthio)phenyl]-2-morpholinopropan-1-one (Omnirad 907, manufactured by IGM Resins B.V.), 2,4,6-trimethylbenzoyldiphenylphosphine oxide (Omnirad TPO, manufactured by IGM Resins B.V.), and bis(2,4,6-trimethylbenzoyl)phenylphosphine oxide (Omnirad 819, manufactured by IGM Resins B.V.).

The content of the photopolymerization initiator may be 1 part by mass or more and 10 parts by mass or less, 2 parts by mass or more and 8 parts by mass or less, or 3 parts by mass or more and 7 parts by mass or less, with respect to 100 parts by mass of the total amount of the polydimethylsiloxane compound and the photopolymerizable compound.

The resin composition may further contain a silane coupling agent, a leveling agent, an antifoaming agent, an antioxidant, a sensitizer, and the like.

The silane coupling agent is not particularly limited as long as it does not interfere with curing of the resin composition. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy) silane, β-(3,4-epoxycyclohexyl)-ethyltrimethoxysilane, dimethoxydimethylsilane, diethoxydimethylsilane, 3-acryloxypropyltrimethoxysilane, γ-glycidoxypropyltrimethoxysilane, γ-glycidoxypropylmethyldiethoxysilane, γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl)propyl] tetrasulfide, bis-[3-(triethoxysilyl)propyl] disulfide, γ-trimethoxysilylpropyldimethylthiocarbamoyl tetrasulfide, and γ-trimethoxysilylpropylbenzothiazyl tetrasulfide.

From the viewpoint of coloring the resin layer, the resin composition according to the present embodiment can further contain titanium oxide particles. As the titanium oxide particles, surface-treated titanium oxide particles may be used. The surface-treated titanium oxide particles are particles obtained by subjecting titanium oxide to a surface treatment using an inorganic substance, and have excellent dispersibility in the resin composition.

Examples of the inorganic substance used for the surface treatment include aluminum oxide, silicon dioxide, and zirconium dioxide. When the surface-treated titanium oxide particles have a surface-treated layer containing at least one selected from the group consisting of aluminum oxide, silicon dioxide, and zirconium dioxide, dispersibility can be further improved. The surface-treated layer may be formed on at least a portion of the surface of the titanium oxide, or may be formed over the entire surface of the titanium oxide. The surface-treated layer is formed by a surface treatment of titanium oxide. From the viewpoint of improving dispersibility, the amount of the surface-treated layer in the surface-treated titanium oxide particles may be 1% by mass or more, 1.5% by mass or more, or 2% by mass or more, and from the viewpoint of enhancing the hiding power, the amount of the surface-treated layer may be 10% by mass or less, 9% by mass or less, or 8% by mass or less. The amount of the surface-treated layer can be calculated by measuring the amounts of titanium element and the elements of the inorganic substance other than titanium included in the surface-treated titanium oxide particles using inductively coupled plasma mass spectrometry (ICP-MS).

From the viewpoint of improving the lateral pressure resistance of the coating resin layer, the average primary particle size of the surface-treated titanium oxide particles may be 300 nm or less, 295 nm or less, or 290 nm or less. From the viewpoint of enhancing the hiding power, the average primary particle size of the surface-treated titanium oxide particles may be 100 nm or more, 150 nm or more, or 200 nm or more, and may be 200 nm or more and 300 nm or less. The average primary particle size can be measured by, for example, image analysis of electron microscopic photographs, a light scattering method, or a BET method.

From the viewpoint of improving the visibility of the resin layer, the content of the surface-treated titanium oxide particles may be 0.6% by mass or more, 1% by mass or more, 2% by mass or more, or 3% by mass or more, based on the total amount of the resin composition. From the viewpoint of enhancing the curability of the resin composition, the content of the surface-treated titanium oxide particles may be 20% by mass or less, 15% by mass or less, 10% by mass or less, or 8% by mass or less, based on the total amount of the resin composition.

When the elongation at break of a resin film obtained by curing the resin composition according to the present embodiment at an integrated light dose of 900 mJ/cm² or more and 1100 mJ/cm² or less is 6% or more and 50% or less at 23° C., a resin layer having excellent toughness can be formed. The elongation at break of the resin film may be 6.5% or more, 7% or more, or 10% or more, and may be 45% or less, 40% or less, or 30% or less.

From the viewpoint of further improving the wet heat resistance of the optical fiber, the Young's modulus at 23° C. of the resin film may be 400 MPa or greater, 450 MPa or greater, or 500 MPa or greater. From the viewpoint of forming a resin layer having excellent toughness, the Young's modulus at 23° C. of the resin film may be 1500 MPa or less, 1200 MPa or less, or 1000 MPa or less.

The resin composition according to the present embodiment can be suitably used as a colored coating material of an optical fiber. By forming an outermost layer of the coating resin layer using a colored coating material including the resin composition according to the present embodiment, the wet heat resistance of the optical fiber can be improved.

### (Optical Fiber)

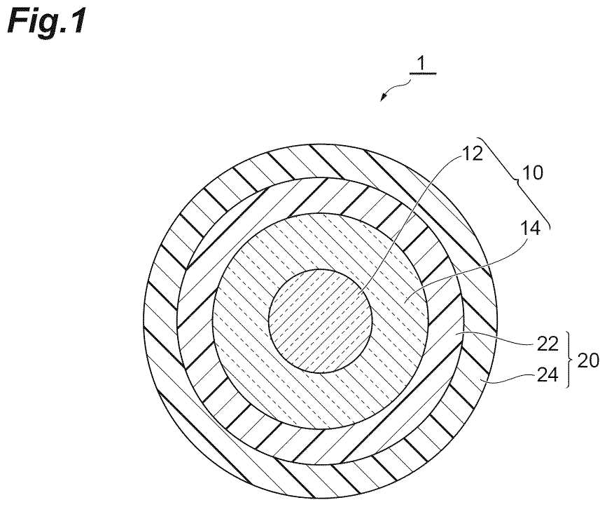

FIG. 1 is a schematic cross-sectional view illustrating a configuration of an optical fiber according to an embodiment. As shown in FIG. 1, the optical fiber 1 includes a glass fiber 10 and a coating resin layer 20 being in contact with the glass fiber 10 and covering the outer periphery of the glass fiber 10.

The glass fiber 10 is a light-guiding optical transmission medium transmitting light introduced into the optical fiber 1. The glass fiber 10 is a member made of glass and is formed using silica (SiO₂) glass as a base material (main component). The glass fiber 10 includes a core 12 and a cladding 14 covering the core 12. The glass fiber 10 transmits the light introduced into the optical fiber 1. The core 12 is provided in, for example, a region including the central axial line of the glass fiber 10. The core 12 is formed from a material containing, for example, pure SiO₂ glass, or SiO₂ glass containing GeO₂ and/or fluorine element, or the like. The cladding 14 is provided in a region surrounding the core 12. The cladding 14 has a refractive index lower than the refractive index of the core 12. The cladding 14 is formed from, for example, pure SiO₂ glass, or SiO₂ glass added with fluorine element. The outer diameter of the glass fiber 10 is about 100 μm to 125 μm, and the diameter of the core 12 constituting the glass fiber 10 is about 7 μm to 15 μm.

The coating resin layer 20 is an ultraviolet-curable resin layer covering the cladding 14. The coating resin layer 20 includes a primary resin layer 22 coating the outer periphery of the glass fiber 10, and a secondary resin layer 24 coating the outer periphery of the primary resin layer 22. The primary resin layer 22 is in contact with the outer peripheral surface of the cladding 14 and coats the entire cladding 14. The secondary resin layer 24 is in contact with the outer peripheral surface of the primary resin layer 22 and coats the entire resin layer 22. The thickness of the primary resin layer 22 is, for example, 10 μm or more and 50 μm or less. The thickness of the secondary resin layer 24 is, for example, 10 μm or more and 40 μm or less.

The resin composition according to the present embodiment can be applied to the secondary resin layer 24. The secondary resin layer 24 can be formed by curing the above-described resin composition. As the secondary resin layer 24 contains a cured product of the resin composition according to the present embodiment, the single core separability and wet heat resistance of the optical fiber can be improved without causing color peeling.

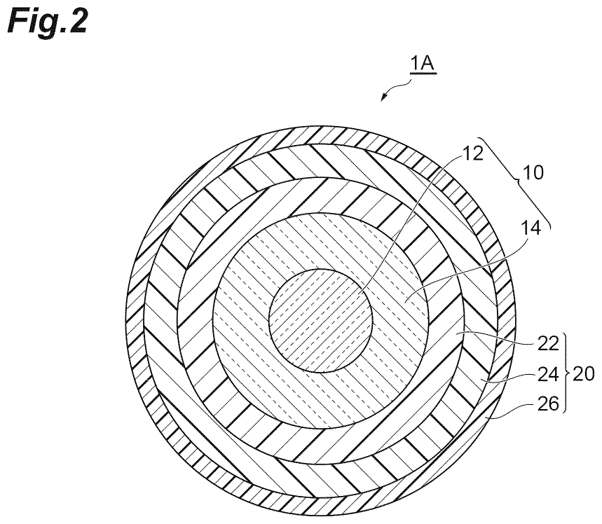

The coating resin layer 20 may further include a colored resin layer 26 coating the outer periphery of the secondary resin layer 24. FIG. 2 is a schematic cross-sectional view illustrating a configuration of the optical fiber according to an embodiment. As shown in FIG. 2, the optical fiber 1A of the present embodiment includes a glass fiber 10 and a coating resin layer 20 being in contact with the glass fiber 10 and covering the outer periphery of the glass fiber 10. The coating resin layer 20 includes a primary resin layer 22, a secondary resin layer 24, and a colored resin layer 26. The thickness of the colored resin layer 26 is, for example, 3 μm or more and 10 μm or less.

The resin composition according to the present embodiment can be applied to the colored resin layer 26. The colored resin layer 26 can be formed by curing the above-described resin composition. As the colored resin layer 26 contains a cured product of the resin composition according to the present embodiment, the colored resin layer 26 can improve the single core separability and wet heat resistance of the optical fiber without causing color peeling. The secondary resin layer 24 in the optical fiber 1A may be formed using a conventionally known resin composition, and can be formed by curing a resin composition containing, for example, urethane (meth)acrylate, a monomer, and a photopolymerization initiator.

The primary resin layer 22 can be formed by curing a resin composition containing, for example, urethane (meth)acrylate, a monomer, a photopolymerization initiator, and a silane coupling agent. The resin composition for the primary resin layer can be prepared using a conventionally known technology.

### (Optical Fiber Ribbon)

An optical fiber ribbon can be produced using the optical fiber according to the present embodiment. In the optical fiber ribbon, a plurality of the above-described optical fibers are arranged in parallel and are coated with a resin for ribbon.

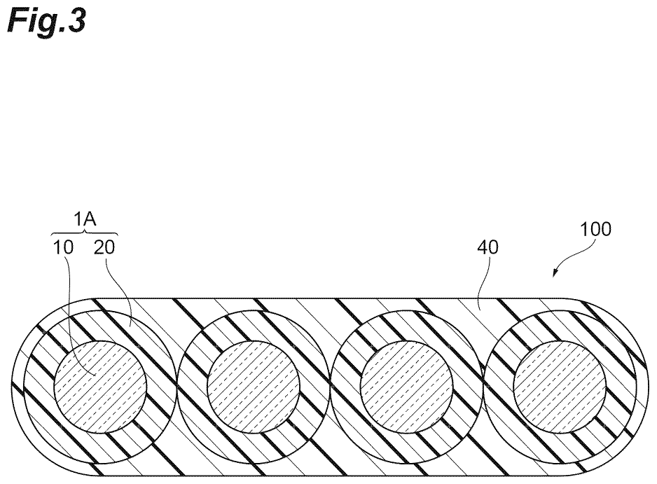

FIG. 3 is a schematic cross-sectional view illustrating an optical fiber ribbon according to the present embodiment. The optical fiber ribbon 100 has a plurality of optical fibers 1A and a connecting resin layer 40 in which the optical fibers 1A are coated and connected by a resin for ribbon. In FIG. 3, four optical fibers are shown as an example; however, the number of the optical fibers is not particularly limited.

As the resin for ribbon, a resin material generally known as a ribbon material can be used. From the viewpoints of the property of preventing damage to the optical fibers, easy separability, and the like, the resin for ribbon may contain a thermosetting resin such as a silicone resin, an epoxy resin, or a urethane resin; or an ultraviolet-curable resin such as epoxy acrylate, urethane acrylate, or polyester acrylate.

In the optical fiber ribbon according to the present embodiment, by using the above-described optical fibers, color peeling does not occur when an operation of removing the connecting resin layer from the optical fiber ribbon and taking out the optical fibers is carried out, and the optical fibers can be easily identified.

### EXAMPLES

Hereinafter, results of evaluation tests using the Examples and Comparative Examples according to the present disclosure will be shown, and the present disclosure will be described in more detail. Incidentally, the present disclosure is not limited to these Examples.

### [Resin Composition for Colored Resin Layer]

### (Polydimethylsiloxane Compound)

The polydimethylsiloxane compounds shown in Table 1 were prepared. The amount of Si contained in the polydimethylsiloxane compound was measured by the following procedure using ICP-OES. First, a decomposition solution of a polydimethylsiloxane compound was obtained by adding 2 mL of hydrofluoric acid and 6 mL of nitric acid to 0.1 g of a polydimethylsiloxane compound, subsequently raising the temperature to 200° C. in 30 minutes using a microwave decomposition apparatus, maintaining the temperature for 20 minutes, and then lowering the temperature to normal temperature. Next, the decomposition solution was diluted 10-fold to 100-fold with ultrapure water to produce samples. The amount of Si contained in the polydimethylsiloxane compound was calculated by quantifying Si in the sample using an ICP emission spectrophotometer (“iCAP 6300” manufactured by Thermo Fisher Scientific Inc.).

TABLE 1

| | Number | |
|---|---|---|
| | of (meth) | Amount |
| | acryloyl | of Si |
| | groups | (%) |
| PDMS-1 | 0 | 38 |
| PDMS-2 | 8 | 30 |
| PDMS-3 | 2 | 21 |
| PDMS-4 | 2 | 18 |
| PDMS-5 | 2 | 10 |
| PDMS-6 | 5 | 3 |

### (Photopolymerizable Compound)

As photopolymerizable compounds, bisphenol A epoxy diacrylate (EA), tripropylene glycol diacrylate (TPGDA), EO-modified trimethylolpropane triacrylate (TMP(EO)₃TA), and EO-modified bisphenol A diacrylate (BPA(EO)₃₀DA) were prepared.

As photopolymerization initiators, 2,4,6-trimethylbenzoyldiphenylphosphine oxide (Omnirad TPO) and 1-hydroxycyclohexyl phenyl ketone (Omnirad 184) were prepared.

As titanium oxide particles, surface-treated titanium oxide particles having a surface-treated layer containing aluminum oxide (Al₂O₃) were prepared. The average primary particle size of the surface-treated titanium oxide particles was 200 to 300 nm, and the amount of Al₂O₃ calculated by ICP-MS measurement was 2.5% by mass.

A polydimethylsiloxane compound, a photopolymerizable compound, and a photopolymerization initiator in the blending amounts (parts by mass) indicated in Table 2 were mixed, and then surface-treated titanium oxide particles were mixed such that the content of the surface-treated titanium oxide particles in the resin composition was 5% by mass, to prepare a resin composition. Test Examples 1 to 5 correspond to Examples, and Test Examples 6 and 7 correspond to Comparative Examples.

### (Stability)

After the resin composition was prepared, the resin composition was put in a constant-temperature bath at 25° C. and stored. A case in which there was no change in the appearance of the resin composition after one day was rated as “A”, and a case in which phase separation and the like occurred in the resin composition within one day was rated as “B”.

### (Young's Modulus)

The resin composition was applied on a polyethylene terephthalate (PET) film using a spin coater, and then the resin composition was cured using an electrodeless UV lamp system (“VPS600 (D bulb)” manufactured by Heraeus Group) under the conditions of 1000±100 mJ/cm², to form a resin layer having a thickness of 50±5 μm on the PET film. The resin layer was peeled from the PET film, and a resin film was obtained.

The resin film was punched into a dumbbell shape of JIS K 7127 Type 5, the punched resin film was pulled under the conditions of 23° C.±2° C. and 50±10% RH, by using a tensile testing machine under the conditions of a tensile rate of 1 mm/min and a gauge length of 25 mm, and a stress-strain curve was obtained. The Young's modulus was determined using a 2.5% secant line.

### (Resin Composition for Primary Resin Layer)

A urethane acrylate oligomer obtained by reacting polypropylene glycol having a molecular weight of 4000, isophorone diisocyanate, hydroxyethyl acrylate, and methanol, was prepared. A resin composition P was prepared by mixing 75 parts by mass of this urethane acrylate oligomer, 12 parts by mass of nonylphenol EO-modified acrylate, 6 parts by mass of N-vinylcaprolactam, 2 parts by mass of 1,6-hexanediol diacrylate, 1 part by mass of Omnirad TPO, and 1 part by mass of 3-mercaptopropyltrimethoxysilane.

### (Resin Composition for Secondary Resin Layer)

A resin composition S was prepared by mixing 40 parts by mass of a urethane acrylate oligomer which was a reaction product of polypropylene glycol having a molecular weight of 600, 2,4-tolylene diisocyanate, and 2-hydroxyethyl acrylate, 35 parts by mass of isobornyl acrylate, 24 parts by mass of epoxy acrylate which was an acrylic acid adduct of bisphenol A diglycidyl ether, 1 part by mass of Omnirad TPO, and 1 part by mass of Omnirad 184.

### (Resin Composition for Ribbon)

A resin composition R was prepared by mixing 18 parts by mass of urethane acrylate which was a reaction product of bisphenol A-ethylene oxide adduct diol, tolylene diisocyanate, and hydroxyethyl acrylate, 10 parts by mass of urethane acrylate which was a reaction product of polytetramethylene glycol, tolylene diisocyanate, and hydroxyethyl acrylate, 15 parts by mass of tricyclodecanedimethanol diacrylate, 10 parts by mass of N-vinylpyrrolidone, 10 parts by mass of isobornyl acrylate, 5 parts by mass of bisphenol A-ethylene oxide adduct diol diacrylate, 0.7 parts by mass of 2-methyl-1-[4-(methylthio)phenyl]-2-morpholinopropan-1-one (Omnirad 907), and 1.3 parts by mass of Omnirad TPO.

### [Production of Optical Fiber]

A primary resin layer having a thickness of 17.5 μm was formed using the resin composition P on the outer periphery of a glass fiber composed of a core and a cladding and having a diameter of 125 μm, and a secondary resin layer having a thickness of 15 μm was formed using the resin composition S on the outer periphery of the primary resin layer to produce an optical fiber. Next, the optical fiber was first wound up, and then a colored resin layer having a thickness of 5 μm was formed using each of the resin compositions of Test Examples 1 to 7 on the outer periphery of the secondary resin layer while letting out the optical fiber again with a coloring machine, to produce an optical fiber having a diameter of 200 μm and having a colored resin layer (hereinafter, referred to as a “colored optical fiber”). The linear speed at the time of forming each resin layer was set to 1500 m/min.

### [Production of Optical Fiber Ribbon]

Four colored optical fibers were prepared and coated with the resin composition R for ribbon, subsequently the resin composition was cured by irradiating with ultraviolet radiation to form a connecting resin layer, and an optical fiber ribbon was produced.

### (Color Peeling Test)

The optical fiber ribbon was stored in an environment at 85° C. and 85% RH (dark place) for 90 days, and then the optical fibers were separated from the optical fiber ribbon into single cores according to Telcordia GR-20 5.3.1. The presence or absence of peeling of the colored resin layer at that time was evaluated. A case in which peeling of the colored resin layer did not occur was rated as “A”, a case in which a portion of the resin for ribbon remained on the colored resin layer was rated as “B”, and a case in which peeling of the colored resin layer occurred was rated as “C”.

TABLE 2

| Test Example | 1 | 2 | 3 | 4 | 5 | 6 | 7 |
|---|---|---|---|---|---|---|---|
| EA | 55.0 | 55.0 | 55.0 | 55.0 | 55.0 | 55.0 | 56.0 |
| TPGDA | 13.5 | 13.5 | 13.5 | 13.5 | 13.5 | 13.5 | 14.0 |
| TMP(EO)₃TA | 9.5 | 9.5 | 9.5 | 9.5 | 9.5 | 9.5 | 10.0 |
| BPA(EO)₃₀DA | 19.5 | 19.5 | 19.5 | 19.5 | 19.5 | 19.5 | 20.0 |
| PDMS-1 | 2.5 | — | — | — | — | — | — |
| PDMS-2 | — | 2.5 | — | — | — | — | — |
| PDMS-3 | — | — | 2.5 | — | — | — | — |
| PDMS-4 | — | — | — | 2.5 | — | — | — |
| PDMS-5 | — | — | — | — | 2.5 | — | — |
| PDMS-6 | — | — | — | — | — | 2.5 | — |
| Omnirad 184 | 6.0 | 6.0 | 6.0 | 6.0 | 6.0 | 6.0 | 6.0 |
| Omnirad TPO | 1.0 | 1.0 | 1.0 | 1.0 | 1.0 | 1.0 | 1.0 |
| TiO₂ (% by mass) | 5.0 | 5.0 | 5.0 | 5.0 | 5.0 | 5.0 | 5.0 |
| Stability | B | A | A | A | A | A | A |
| Young's modulus | 1100 | 1100 | 1100 | 1100 | 1100 | 1100 | 1150 |
| (MPa) | | | | | | | |
| Color peeling test | A | A | A | A | B | C | C |

### REFERENCE SIGNS LIST

1, 1A: optical fiber,
10: glass fiber,
12: core,
14: cladding,
20: coating resin layer,
22: primary resin layer,
24: secondary resin layer,
26: colored resin layer,
40: connecting resin layer,
100: optical fiber ribbon.

What is claimed is:

1. A resin composition for colored coating of an optical fiber, the resin composition comprising a photopolymerizable compound, a photopolymerization initiator, and a polydimethylsiloxane compound,
wherein an amount of silicon atoms included in the polydimethylsiloxane compound is 5% by mass or more and 40% by mass or less based on an amount of the polydimethylsiloxane compound.

2. The resin composition according to claim 1, wherein the polydimethylsiloxane compound has a (meth)acryloyl group.

3. The resin composition according to claim 1, wherein the photopolymerizable compound includes epoxy di(meth)acrylate.

4. The resin composition according to claim 1, further comprising titanium oxide.

5. An optical fiber comprising
a glass fiber including a core and a cladding;
a primary resin layer in contact with the glass fiber and coating the glass fiber;
a secondary resin layer coating the primary resin layer; and
a colored resin layer coating the secondary resin layer,
wherein the colored resin layer contains a cured product of the resin composition according to claim 1.

6. An optical fiber comprising:
a glass fiber including a core and a cladding;
a primary resin layer in contact with the glass fiber and coating the glass fiber; and
a secondary resin layer coating the primary resin layer,
wherein the secondary resin layer contains a cured product of the resin composition according to claim 1.

7. An optical fiber ribbon comprising a plurality of the optical fibers according to claim 5 arranged in parallel and coated with a resin for ribbon.

8. An optical fiber ribbon comprising a plurality of the optical fibers according to claim 6 arranged in parallel and coated with a resin for ribbon.
